(19) United States
(12) Patent Application Publication
(10) Pub. No.: US 2013/0262790 A1
(43) Pub. Date: Oct. 3, 2013

(54) METHOD, COMPUTER PROGRAM AND DEVICE FOR MANAGING MEMORY ACCESS IN A MULTIPROCESSOR ARCHITECTURE OF NUMA TYPE

(71) Applicants: Zoltan Menyhart, Grenoble (FR); Marc Perache, Roinville-sous-Dourdan (FR)

(72) Inventors: Zoltan Menyhart, Grenoble (FR); Marc Perache, Roinville-sous-Dourdan (FR)

(73) Assignees: COMMISSARIAT A L'ENERGIE ATOMIQUE ET AUX ENERGIES ALTERNATIVES, Paris (FR); BULL SAS, Les Clayes Sous Bois (FR)

(21) Appl. No.: 13/993,665

(22) PCT Filed: Nov. 21, 2011
(86) PCT No.: PCT/FR2011/052713

§ 371 Date: Jun. 12, 2013

(30) Foreign Application Priority Data
Dec. 13, 2010 (FR) 1060423

(51) Int. Cl. G06F 12/14

(52) U.S. Cl. CPC G06F 12/1475
USPC 711/152

(57) ABSTRACT

Managing memory access in a non-uniform memory access (NUMA) multiprocessor architecture including two computation units and at least two separate memories is disclosed. Each memory, including at least one logic memory entity, is locally associated with a computation unit. After receiving a control for access to a logic memory entity, the status of an indicator of the status of the logic memory entity (first entity) to which the received command applies is determined. If the indicator is in a first state, the received control is executed. If, on the contrary, the indicator is in a second state, data stored in the first entity is migrated into a second logic memory entity of a memory separate from the memory including the first entity, and the status of the second entity is placed into the first state.

### CROSS-REFERENCE TO RELATED APPLICATIONS

This application is a U.S. National Phase under 35 U.S.C. §371 of International Application PCT/FR2011/052713, filed Nov. 21, 2011, which designated the U.S., and which claims priority under 35 U.S.C. §119 to France Patent Application Number FR 1060423, filed on Dec. 13, 2010. The disclosures of the above-described applications are hereby expressly incorporated by reference in their entireties.

### BACKGROUND

1. Field

The disclosed technology concerns the management of the memory in a computer system and more particularly a method, a computer program and a device for managing memory access in a multiprocessor architecture of a non-uniform memory access (NUMA) type.

2. Description of the Related Technology

Due to the physical constraints linked to microprocessors which limit their performance, architectures have been developed based on the implementation of several microprocessors, making it possible to perform parallel computations. These multiprocessor architectures enable the execution of a high number of applications and/or of applications divided up into steps, using a large amount of computation.

However, the implementation of such architectures requires particular mechanisms, in particular to manage the accesses to the memory circuits used.

There are essentially two approaches to enable each microprocessor to access a memory location.

According to a first solution, also called UMA type SMP (UMA being an acronym for Uniform Memory Access and SMP standing for Symmetric MultiProcessing), illustrated in FIG. 1a, a common memory location is shared between all the microprocessors. Thus, according to that example, the memory 100 is accessible by each of the microprocessors 105-1 to 105-4 via the system bus 110.

The efficiency of this solution, which may be considered as a direct evolution from monoprocessor architectures, is directly linked to the number of microprocessors used (the memory can only be accessed by one microprocessor at a given time). Consequently, this solution is not adapted to the massively parallel architectures employing a high number of microprocessors.

According to a second solution, also termed NUMA architecture (NUMA being an acronym for Non Uniform Memory Access), illustrated in FIG. 1b, a local memory location is associated with each microprocessor, each microprocessor nevertheless being capable of accessing a local memory location associated with another microprocessor.

By way of illustration, the memories 100′-1 to 100′-4 are associated here with the microprocessors 105′-1 to 105′-4, respectively. Thus, each microprocessor 105′-i can access the memory associated with it, called local memory, as well as the memory associated with the other microprocessors, called remote memories, via the system bus 110′.

However, as the name of this architecture indicates, the access time to a remote memory is greater than the access time to a local memory.

The memory formed by all the local memories may be considered as an overall memory represented by a memory table shared between the microprocessors. This table makes it possible in particular to manage the access rights, in particular the rights for reading/writing, in order, for example, to prohibit the simultaneous writing of an item of data to a given location by several microprocessors. This memory table also makes it possible to establish a link between the physical addresses and the references used to access the memory content (logical addresses, virtual addresses, content, etc.).

The memory table is generally managed by the operating system, also called OS (standing for Operating System), which may in particular be executed by one of the microprocessors.

The memory management is generally carried out by pages, that is to say by logical units of memory. Typically a page represents a line of memory in the matrix structure formed by one or more components. The size of a page is, for example, four thousand bytes.

### SUMMARY OF CERTAIN INVENTIVE ASPECTS

The allocation of the memory in a NUMA type architecture is generally static. It may be made using an equitable sharing mechanism, for example cyclically, or according to the mechanism called “first touch” whereby the allocation is made according to the application at the origin of the request for memory allocation, the microprocessor on which it is executed and the associated local memory.

However, to optimize the efficiency of several applications executed on a NUMA type architecture and which work on common data, a data migration mechanism may be implemented. It makes it possible to move data used by several microprocessors from one local memory to another. This may be a deliberate migration specifying the destination local memory or be a migration based on statistics established by the system implementing those applications.

Although it is able to optimize memory accesses for certain configurations of applications, such a mechanism is nevertheless complex to implement and does not necessarily enable good performance to be achieved for the execution of the applications. Furthermore, it is not always available.

Various aspects of the disclosed technology enable at least one of the problems set forth above to be solved.

One aspect of the disclosed technology thus relates to a method of managing memory access in a multiprocessor architecture of NUMA type comprising at least two computing units and at least two distinct memories, each of the at least two memories being associated, locally, with one of the at least two computing units, each of the at least two memories comprising at least one logical memory entity, the method comprising when at least one access command concerning at least one of the logical memory entities is received:

determining the state of a status flag of the at least one of said logical memory entities, called at least one first logical memory entity, concerned by the at least one received command;

if the status flag of the at least one first logical memory entity is in a first state, executing the at least one received command; and,

if the status flag of the at least one first logical memory entity is in a second state,
migrating data stored in the at least one first logical entity into at least one logical memory entity, called at least one second logical memory entity, of a memory that is distinct from the memory comprising the at least one first logical memory entity; and,
setting the status of the at least one second logical memory entity to the first state.

The method thus makes it possible to automatically and simply manage the location for data storage in order to optimize the execution of applications using those data, without substantial modification of the applications or of their execution environment.

According to a particular embodiment, setting the status of the at least one second logical memory entity to the first state further comprises modifying the link between a physical address of the migrated data and an item of logical information enabling identification of the migrated data to easily identify the location of the migrated data.

According to a particular embodiment, the at least one item of logical information is a logical address, a virtual address, or part of the migrated data.

The method further comprises, if the status flag of the at least one first logical memory entity is in a second state, executing the received command executed after setting the at least one second logical memory entity to the first state for accessing the migrated data.

According to a particular embodiment, a memory access error is generated if the status flag of the at least one first logical memory entity is in a second state, the migrating and setting the status of the at least one second logical memory entity to the first state being executed in response to the detection of the memory access error. The method is thus particularly easy to implement with an operating system such as Linux.

Advantageously, the method further comprises setting the status of the at least one first logical memory entity to the second state in response to a command directed to caching the at least one first logical memory entity in order to enable a later migration from the at least one first logical memory entity if an access thereto is made. The setting the status of the at least one first logical memory entity to the second state is executed at the end of the execution of an application executed by the computing unit associated with the memory comprising the at least one first logical memory entity to enable the migration from the at least one first logical memory entity to a local memory of a computing unit accessing that logical memory entity. Thus, the data used by applications are, if possible, stored in local memories of the computing units executing those applications.

According to a particular embodiment, the logical memory entities are pages and the computing units are microprocessors.

The method is advantageously implemented by the operating system used by the at least two computing units.

Another aspect of the disclosed technology is also directed to a computer program comprising instructions adapted to the implementation of the method described earlier when the program is executed by a computer as well as to a device comprising components adapted to the implementation of the method described earlier.

In various aspects, the advantages provided by the computer program and the device are similar to those referred to above.

### BRIEF DESCRIPTION OF THE DRAWINGS

Other advantages, objects and features will emerge from the following detailed description, given by way of non-limiting example, relative to the accompanying drawings in which:

FIG. 1, comprising FIGS. 1a, 1b and 1c, is a block diagram diagrammatically representing examples of microprocessor structures.

FIG. 2 is an example flowchart diagrammatically illustrating an example algorithm of the memory access manager, capable of being implemented by the operating system, when a command for access to data or directed to caching a logical memory entity is received, enabling the migration of data.

FIG. 3 is an example flowchart, comprising FIGS. 3a and 3b, diagrammatically illustrating the memory manager of the operating system when a command for access to data or directed to caching a logical memory entity is received and when the rights associated with the executed applications do not enable the migration to be carried out directly.

### DETAILED DESCRIPTION OF CERTAIN EMBODIMENTS

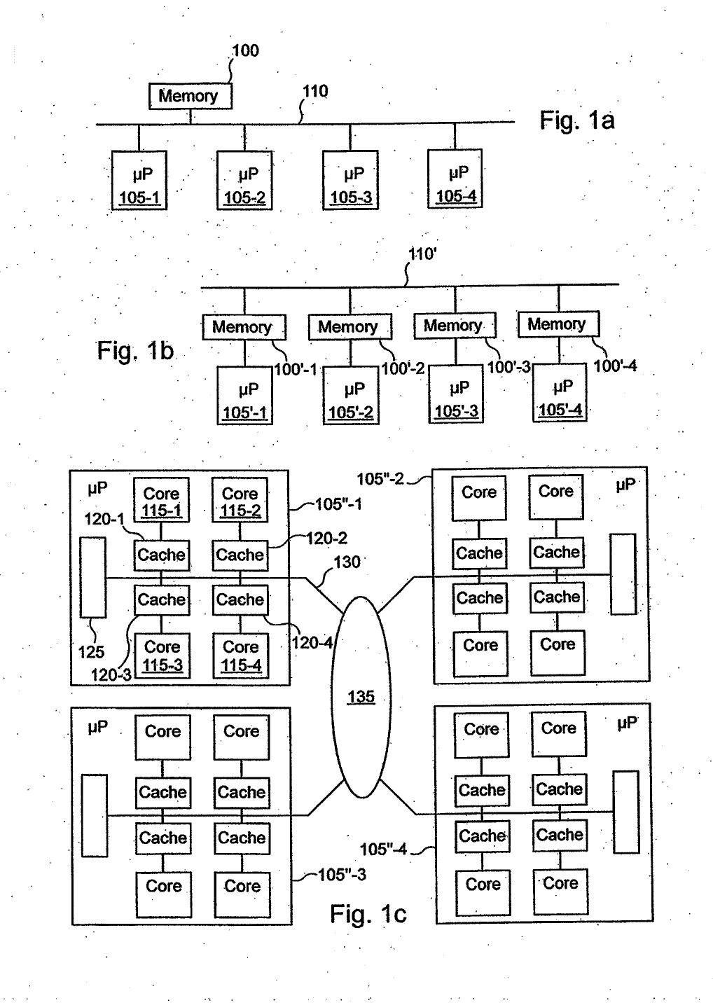

FIG. 1c illustrates a second example of implementation of a NUMA type architecture. According to this example, each microprocessor 105″-1 to 105″-4 comprises four elementary computing units, also called cores (or CPUs, standing for Central Processing Units). A cache memory is associated with each core. A common local memory is associated with all the cores of a microprocessor. Thus, the microprocessor 105″-1 comprises the four cores 115-1 to 115-4 with which are associated the cache memories 120-1 to 120-4, respectively. The microprocessor 105″-1 further comprises the shared local memory 125. It may access the local memories of the other microprocessors via the bus 130 and the internal network switch 135.

The disclosed technology generally concerns the migration of data contained in logical memory entities, such as pages, from one local memory associated with a first computing unit, for example a microprocessor, to another local memory associated with a second computing unit. This migration takes place when an application executed on the first computing unit no longer needs to access the data stored in those logical memory entities whereas the second computing unit requires access thereto.

More specifically, on termination of a step (also called thread) of an application (also called process), executed by a first computing unit and using data stored in logical memory entities of a memory local to that first computing unit, it caches (or frees) those logical memory entities. The data contained in them may then migrate into logical memory entities of another local memory associated with another computing unit to enable a step of an application executed by the latter to locally access the data stored in those logical memory entities.

After migration, the stored data are no longer available in the local memory associated with the first computing unit.

For these purposes, an additional flag is associated with each logical memory entity, that is to say, for example, with each page, to define a status. The status may here take at least one of the following two states, which can be coded over one bit: “accessible” and “cached”. In other words, that flag represents the authorization or prohibition to migrate the data from the corresponding logical memory entity. Thus, in the context of the disclosed technology, a logical memory entity such as a page is said to be cached if its state requires prior migration before any reading and/or writing action.

By way of illustration, when the Linux operating system is used (Linux is a trademark), that flag may be stored in the form of a flag PROT_MIGR in the variable prot of the function for protecting memory accesses mprotect( ) defined in the following way:

int mprotect(const void*addr, size_t len, int prot);

This flag may be added to the variable prot in the following way:

PROT_READ|PROT_WRITE|PROT_MIGR

It thus marks the cached or inaccessible pages the content of which may migrate.

This flag is preferably stored in the memory table. When the status of a logical memory entity is “cached”, the data contained in that logical memory entity are no longer directly accessible and may be migrated. They are thus migrated, if necessary, that is to say if they are not contained in a local memory of the microprocessor executing the application requiring its use, before being accessible again. Table 1, shown below, illustrates an example of a memory table. As illustrated, this table comprises a first column representing a logical address, a virtual address, a content or any other flag enabling a memory location corresponding to a logical memory entity to be located.

TABLE 1

| Logical address | | | |
|---|---|---|---|
| (or virtual | | | |
| address, content | | | |
| or other flag) | Physical address | Status | |
| . . . | . . . | . . . | Local memory 1 |
| . . . | . . . | . . . | |
| Virtual address i | Physical address j | “cached” | |
| . . . | . . . | . . . | |
| Virtual address k | Physical address l | “accessible” | |
| . . . | . . . | . . . | Local memory 2 |
| . . . | . . . | . . . | |
| . . . | . . . | . . . | |
| . . . | . . . | . . . | |
| . . . | . . . | . . . | |
| . . . | . . . | . . . | Local memory 3 |
| . . . | . . . | . . . | |
| . . . | . . . | . . . | |
| . . . | . . . | . . . | |
| . . . | . . . | . . . | |
| . . . | . . . | . . . | Local memory 4 |
| . . . | . . . | . . . | |
| . . . | . . . | . . . | |
| . . . | . . . | . . . | |
| . . . | . . . | . . . | |

It also comprises a second column representing the physical addresses associated with those logical addresses, virtual addresses, contents or other flags enabling a memory location corresponding to a logical memory entity to be located.

Lastly, this table further comprises a third column in which are stored the statuses associated with each logical memory entity.

The memory table example illustrated here correspond to a NUMA type architecture in which four distinct local memories are used (as indicated in the fourth column). Each of these memories is, for example, associated with a particular microprocessor.

Thus, by way of illustration, the data corresponding to the virtual address i are accessible at the physical address j in the first local memory. The status corresponding to the logical memory entity comprising those data is “cached”. Thus, the data corresponding to the virtual address i may be migrated.

Similarly, the data corresponding to the virtual address k are accessible at the physical address l in the first local memory. The status corresponding to the logical memory entity comprising those data is “accessible”. Thus, the data corresponding to the virtual address k may not be migrated.

Furthermore, a command such as a system call is, preferably, added to the end of each step (thread) of an application (process) to modify, if required, the status of the logical memory entities comprising the data processed by that application step and belonging to the local memory associated with the computing unit on which the step is executed. This command or this system call is directed to caching one or more logical memory entities to enable the migration of the data contained therein. The fact of caching a logical memory entity here consists in setting its status to the state “cached”.

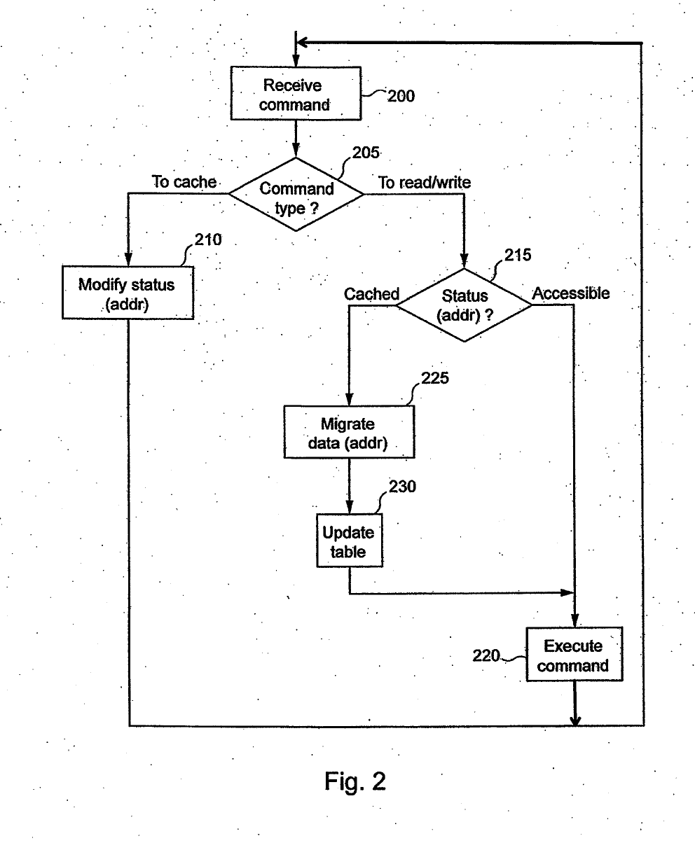

FIG. 2 diagrammatically illustrates certain steps of an example of the general algorithm of the memory access manager, capable of being implemented by the operating system, when a command for access to data, for example a reading or writing command, or a command for caching a logical memory entity, is received, enabling the migration of data.

After having received a command such as a system call (step 200), a test is carried out to determine the type of the command received, that is to say here to determine whether it is a command directed to caching one or more logical memory entities enabling the migration of the data that they contain or whether it is a command for access to data, for example a command for reading or writing data (step 205).

If the command received is a command directed to caching one or more logical memory entities, the corresponding status is modified (step 210). Thus, for example, if a command directed to caching one or more logical memory entities is received with addr as parameter (addr representing a logical address, a virtual address, a content, or any other flag enabling one or more logical memory entities to be located), the status associated with that logical address, virtual address, content, or any other flag enabling a memory location to be located is set to the state “cached”.

It should be noted here that, by its construction, a command directed to caching logical memory entities is sent by an application step at the end of its execution. Thus, the state of this logical memory entity is in the “accessible” state, when the command is issued. Nevertheless, a test (not shown) may be carried out to verify the status of that logical memory entity before changing it.

If the received command is a command for data access, another test is carried out to determine the status of the logical memory entity to be accessed (step 215). This status may be obtained from the memory table according to the parameter addr received with the command to access data (the addr parameter representing a logical address, a virtual address, a content, or any other flag enabling a memory location to be located).

If the status of the logical memory entity to be accessed is “accessible”, the data access command is executed in standard manner (step 220). The memory area accessed may be local or remote relative to the computing unit executing the step which generated the command processed here.

If the status of the logical memory entity to be accessed is “cached”, a data migration function is called (step 225). The object of this function is in particular to determine the physical location of the logical memory entity to be accessed, to determine the local memory associated with the computing unit which sent the data access command and, where required, to allocate in that memory a memory area comprising one or more logical memory entities. It is also directed, where required, to copying data contained in the logical memory entity to be accessed, and possibly in the neighboring logical memory entities, into one or more logical memory entities of the allocated memory area.

This step of migrating data is followed by a step of updating the memory table (step 230). This step consists in particular of changing the status of the logical memory entities of the memory area allocated in the local memory associated with the computing unit that sent the data access command, into which have been migrated the data contained in the accessed logical memory entity (and, possibly, into the neighboring logical memory entities), to place it in the state “accessible”. It also consists, where required, in modifying the link between the physical address where the data have been migrated and the logical address, the virtual address, the content, or the flag used to locate the logical memory entity or entities associated with those data.

It is noted here that if the memory in which the logical memory entity to be accessed is located corresponds to the local memory associated with the computing unit that issued the data access command, the data are not migrated, only their status being updated.

After having updated the memory table, the data access command is executed in standard manner (step 345). It makes it possible to access the logical memory entity in the local memory associated with the computing unit that sent the access command.

Further to the modification of the status of a logical memory entity (step 210) or to the execution of a data access command (step 220), the preceding steps (steps 200 to 230) are repeated to process the following commands received.

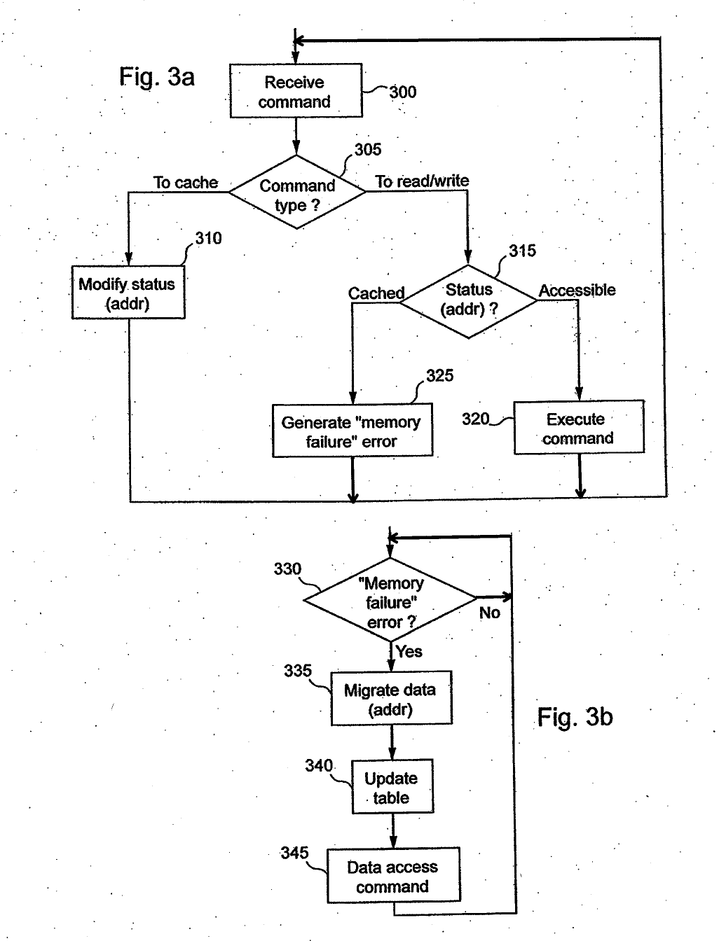

FIG. 3, comprising FIGS. 3a and 3b, diagrammatically illustrates certain steps of the memory manager of the operating system when a data access command, for example a command for reading/writing data, or a command for caching a logical memory entity is received and when the rights associated with the steps and/or with the executed applications do not enable the migration to be carried out directly.

After having received a command such as a system call (step 300), a test is carried out to determine the type of the command received, that is to say here to determine whether it is a command directed to caching one or more logical memory entities enabling the migration of the data that they contain or whether it is a data access command, for example a command for reading or writing data (step 305).

If the command received is a command directed to caching one or more logical memory entities, the status corresponding to those logical memory entities is modified (step 310). Thus, for example, if the command directed to caching one or more logical memory entities is received with addr as parameter (addr representing a logical address, a virtual address, a content, or any other flag enabling one or more logical memory entities to be located), the status associated with that logical address, virtual address, content, or any other flag enabling a memory location to be located is set to the state “cached”.

As indicated previously with reference to FIG. 2, the state of a logical memory entity to be cached can be expected to be in the state “accessible” when the command is issued. Nevertheless, a test (not shown) may be carried out to verify the status of that logical memory entity before changing it.

If the received command is a command for data access, for example a command for reading or writing data, another test is carried out to determine the status of the logical memory entity to be accessed (step 315). This status may be obtained from the memory table according to the parameter addr received with the reading/writing command (the addr parameter representing a logical address, a virtual address, a content, or any other flag enabling a memory location to be located).

If the status of the logical memory entity to be accessed is “accessible”, the data access command is executed in standard manner (step 320). The memory area comprising the accessed logical memory entity may be local or remote relative to the computing unit executing the step (thread) which generated the command processed here.

If the status of the logical memory entity to be accessed is “cached”, an error of “memory failure” type is generated (step 325).

Further to the modification of the status of one or more logical memory entities (step 310), on the execution of a data access command (step 320), or on the generation of an error of “memory failure” type (step 325), the preceding steps (steps 300 to 325) are repeated to process the following commands received.

In parallel with the memory management mechanism, the operating system comprises error management mechanisms. In particular, the operating system comprises an error management mechanism of “memory failure” type as illustrated in FIG. 3b.

When an error of “memory failure” type is detected (step 330), a data migration function is called (step 335). This function is directed to determining the physical location of the logical memory entity the access to which generated the error of “memory failure” type, to determining the local memory associated with the computing unit that sent the command at the origin of the error and, where required, to allocating, in that memory, one or more logical memory entities. It is also directed to copying, where required, the data contained in the logical memory entity the access to which generated the error of “memory failure” type and, possibly, in the neighboring logical memory entities, into the allocated logical memory entity or entities.

This step of migrating data is followed by a step of updating the memory table (step 340). This step consists in particular of changing the status of the logical memory entities of the memory area allocated in the local memory associated with a computing unit that sent the command at the origin of the error, into which have been migrated the data contained in the logical memory entity that generated the error of “memory failure” type and, possibly, in the neighboring logical memory entities, to place it in the state “accessible”. It also consists, where required, in modifying the link between the physical address where the data have been migrated and the logical address, the virtual address, the content, or the flag used to locate the logical memory entity or entities associated with those data.

After having updated the memory table, the error management mechanism sends on the data access command at the origin of the “memory failure” type error (step 345). It is observed that, further to the migration of the data and to the updating of the memory table, this command is executed in a standard way and makes it possible to access the logical memory entity in the local memory associated with the computing unit which sent the access command at the origin of the “memory failure” type error.

Again, it is noted here that if the memory in which the logical memory entity the access to which generated the error of “memory failure” type corresponds to the local memory associated with the computing unit that issued the data access command at the origin of the error, the data are not migrated, only their status being updated.

Steps 330 to 345 are repeated for all the “memory failure” type errors detected.

It should be noted that the steps (threads) of an application (process) share the same memory space and may thus access the same logical memory entities. Similarly, the logical memory entities may be shared between several steps of different application steps. Consequently, certain precautions must be taken when several steps and/or applications may trigger the migration of data contained in the same logical memory entities. Such precautions are, preferably, managed at application level.

When the copy-on-write function is used, the migration mechanism only applies to the last copy. This is generally carried out automatically on account of the protection rules often implemented by operating systems.

Furthermore, it is noted here that the data contained in logical memory entities, for example pages, may be migrated by logical memory entity or by group of logical memory entities. In this case, if the data of a logical memory entity is to be migrated, the data of the neighboring logical memory entities are also migrated if they do not belong to the local memory associated with the computing unit from which came the access command, if they may be migrated, that is to say if their status is “cached”, and if their virtual address is the same as that of the logical memory entity accessed according to a predefined address mask.

By way of illustration, the administrator of a system implementing the Linux operating system may use the following command to enable the migration of several pages:
sysctl -w vm.migrate_page_mask_sh=<n>

The kernel then computes an address mask in the following way:

˜((1UL<<(n+PAGE_SHIFT))−1)

It is thus possible to simultaneously migrate several pages, according to the page number limit imposed by the operating system.

Naturally, to satisfy specific needs, a person skilled in the art will be able to apply modifications in the preceding description.

1-11. (canceled)

12. A method of managing memory access in a multiprocessor architecture of a non-uniform memory access (NUMA) type comprising at least two computing units and at least two distinct memories, each of the at least two memories being associated, locally, with one of the at least two computing units, each of the at least two memories comprising at least one logical memory entity, the method comprising when at least one access command referencing at least one of the logical memory entities is received:
determining a state of a status flag of the at least one of the logical memory entities, identified as at least one first logical memory entity, referenced by the at least one received command;
if the status flag of the at least one first logical memory entity is in a first state, executing the at least one received command; and,
if the status flag of the at least one first logical memory entity is in a second state,
migrating data stored in the at least one first logical entity into at least one logical memory entity, called at least one second logical memory entity, of a memory that is distinct from the memory comprising the at least one first logical memory entity; and,
setting the status of the at least one second logical memory entity to the first state.

13. The method according to claim 12, wherein setting the status of the at least one second logical memory entity to the first state further comprises modifying the link between a physical address of the migrated data and at least one item of logical information enabling identification of the migrated data.

14. The method according to claim 13, wherein the at least one item of logical information is a logical address, a virtual address, or part of the migrated data.

15. The method according to claim 12, further comprising, if the status flag of the at least one first logical memory entity is in a second state, executing the received command executed after setting the at least one second logical memory entity to the first state.

16. The method according to claim 12, wherein a memory access error is generated if the status flag of the at least one first logical memory entity is in a second state, the migrating and setting the status of the at least one second logical memory entity to the first state being executed in response to the detection of the memory access error.

17. The method according to claim 12, further comprising setting the status of the at least one first logical memory entity to the second state in response to a command directed to caching the at least one first logical memory entity.

18. The method according to claim 17, wherein the setting the status of the at least one first logical memory entity to the second state is executed at the end of the execution of an application executed by the computing unit associated with the memory comprising the at least one first logical memory entity.

19. The method according to claim 12, wherein the logical memory entities are pages and wherein the computing units are microprocessors.

20. The method according to claim 12, the method being implemented by the operating system used by the at least two computing units.

21. A computer program comprising instructions adapted for the carrying out the method according to claim 12 when the program is executed by a computer.

22. A device comprising components adapted for the implementation of the method according to claim 12.
